(19) United States
(12) Patent Application Publication
(10) Pub. No.: US 2017/0346341 A1
(43) Pub. Date: Nov. 30, 2017

(54) RESONANCE MODULE AND WIRELESS POWER TRANSMITTER INCLUDING THE SAME

(71) Applicant: Samsung Electro-Mechanics Co., Ltd., Suwon-si (KR)

(72) Inventors: In Wha JEONG, Suwon-si (KR); Hugh KIM, Suwon-si (KR); Jae Suk SUNG, Suwon-si (KR)

(73) Assignee: Samsung Electro-Mechanics Co., Ltd., Suwon-si (KR)

(21) Appl. No.: 15/387,084

(22) Filed: Dec. 21, 2016

(30) Foreign Application Priority Data
May 30, 2016 (KR) 10-2016-0066524

(51) Int. Cl. H02J 50/12; H02J 7/02

(52) U.S. Cl. CPC H02J 50/12; H02J 7/025

(57) ABSTRACT

A wireless power transmitter includes: a switching unit configured to receive a direct current (DC) voltage and to perform switching to output a first alternating current (AC) voltage; a piezoelectric transformer configured to receive the first AC voltage through a first piezoelectric element, and to output a second AC voltage corresponding to mechanical vibration of a second piezoelectric element caused by mechanical vibration of the first piezoelectric element; and a resonator configured to receive the second AC voltage to wirelessly transmit power.

### CROSS-REFERENCE TO RELATED APPLICATIONS

This application claims the benefit under 35 USC 119(a) of Korean Patent Application No. 10-2016-0066524 filed on May 30, 2016 in the Korean Intellectual Property Office, the entire disclosure of which is incorporated herein by reference for all purposes.

### BACKGROUND

### 1. Field

The following description relates to a resonance module and a wireless power transmitter including the resonance module.

### 2. Description of Related Art

In accordance with the development of wireless technology, various wireless functions range from the transmission of data to the transmission of power. Particularly, a wireless power charging technology capable of charging an electronic device with power, even in a non-contact state, has recently been developed.

In the past, a transmitter for wireless charging according to the related art rectified and smoothed a commercial alternating current (AC) voltage into a direct current (DC) voltage to generate DC power, and transformed the generated DC power to wirelessly transmit the power. For example, the transmitter received the DC power of 5V from an adapter, which had produced the DC power of 5V from a commercial AC power source, and transformed the DC power into a high voltage, to be converted into an alternating current, and thereby be able to wirelessly transmit the power.

Therefore, since a wireless power charging apparatus according to the related art now has to employ a separate adapter and also requires a complex circuit configuration such as a transformer circuit, there is a problem in that it is difficult to miniaturize the wireless power charging apparatus.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wireless power transmitter includes: a switching unit configured to receive a direct current (DC) voltage and to perform switching to output a first alternating current (AC) voltage; a piezoelectric transformer configured to receive the first AC voltage through a first piezoelectric element, and to output a second AC voltage corresponding to mechanical vibration of a second piezoelectric element caused by mechanical vibration of the first piezoelectric element; and a resonator configured to receive the second AC voltage to wirelessly transmit power.

The resonator may include a resonance or transmitter coil. The switching unit may be configured to be switched at a frequency corresponding to a resonance frequency of the piezoelectric transformer.

The wireless power transmitter may further include a controller configured to provide a switching control signal to the switching unit to control the switching of the switching unit; and modulate a pulse width of the switching control signal to adjust an output of the resonator.

The resonator may include a resonance capacitor and a resonance coil. The switching unit may be configured to be switched at one of a first frequency corresponding to a resonance frequency of the piezoelectric transformer, and a second frequency which is different from the first frequency.

A frequency band of gain characteristics of the resonator may be wider than a frequency band of gain characteristics of the piezoelectric transformer.

The wireless power transmitter may further include an AC-DC converter configured to receive a commercial AC voltage to output the DC voltage.

The wireless power transmitter may further include: a detector configured to measure a peak voltage level of the commercial AC voltage; and a controller configured to provide a switching control signal to the switching unit to control the switching of the switching unit, and configured to adjust one of a pulse width and a frequency of the switching control signal in response to a change of the peak voltage level.

The controller may be configured to reduce the pulse width of the switching control signal, in response to the peak voltage level exceeding a threshold level.

The controller may be configured to increase the pulse width of the switching control signal, in response to the peak voltage level being less than a threshold level.

The controller may be configured to increase the frequency of the switching control signal, in response to the peak voltage level exceeding a threshold level.

The controller may be configured to reduce the frequency of the switching control signal, in response to the peak voltage level being less than a threshold level.

The controller may be configured to control an output of the wireless power transmitter to be constant by the adjusting of the one of the pulse width and the frequency of the switching control signal.

In another general aspect, a resonance module of a wireless power transmitter includes: a piezoelectric transformer configured to receive a first alternating current (AC) voltage through a first piezoelectric element, and to output a second AC voltage corresponding to mechanical vibration of a second piezoelectric element caused by mechanical vibration of the first piezoelectric element; and a resonator configured to receive the second AC voltage to wirelessly transmit power.

The resonator may include a resonance or transmitter coil. The first AC voltage may have a frequency corresponding to a resonance frequency of the piezoelectric transformer.

The resonator may exclude a capacitor.

The resonator may include a resonance capacitor and a resonance coil. The first AC voltage may have one of a first frequency corresponding to a resonance frequency of the piezoelectric transformer and a second frequency which is different from the first frequency.

A frequency band of gain characteristics of the resonator may be wider than a frequency band of gain characteristics of the piezoelectric transformer.

In another general aspect, a wireless power transmitter includes: a switching unit configured to receive a direct current (DC) voltage and to perform switching to output a first alternating current (AC) voltage; a piezoelectric transformer configured to receive the first AC voltage through a first piezoelectric element, and to output a second AC voltage corresponding to mechanical vibration of a second piezoelectric element caused by mechanical vibration of the first piezoelectric element; a resonator configured to receive the second AC voltage to wirelessly transmit power; and a controller configured to provide a switching control signal to the switching unit to control the switching of the switching unit, and control an output of the wireless power transmitter to be constant by adjusting the switching control signal.

The wireless power transmitter may further include: a converter configured to receive a commercial alternating current (AC) voltage to output the DC voltage, wherein the adjusting of the switching control signal includes adjusting the switching control signal based on the commercial AC voltage.

The wireless power transmitter may further include a detector configured to measure the peak voltage level of the commercial AC voltage.

Other features and aspects will be apparent from the following detailed description, the drawings, and the claims.

### BRIEF DESCRIPTION OF DRAWINGS

FIG. 1 is a diagram illustrating an application of a wireless power transmitter to supply power to a wireless power receiver, according to an embodiment.

FIG. 2 is a block diagram illustrating the wireless power transmitter of FIG. 1, according to an embodiment.

FIG. 3 is a circuit diagram illustrating the wireless power transmitter of FIGS. 1 and 2, according to an embodiment;

FIG. 4 is a circuit diagram illustrating a wireless power transmitter, according to another embodiment.

FIG. 5 is a block diagram illustrating a wireless power transmitter, according to another embodiment.

FIGS. 6 and 7 are diagrams illustrating examples of piezoelectric transformers.

FIG. 8 is a graph illustrating characteristics of a voltage gain with respect to a frequency of a piezoelectric transformer.

FIG. 9 is a graph illustrating characteristics of a voltage gain with respect to a frequency of a wireless power transmitter, according to an embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

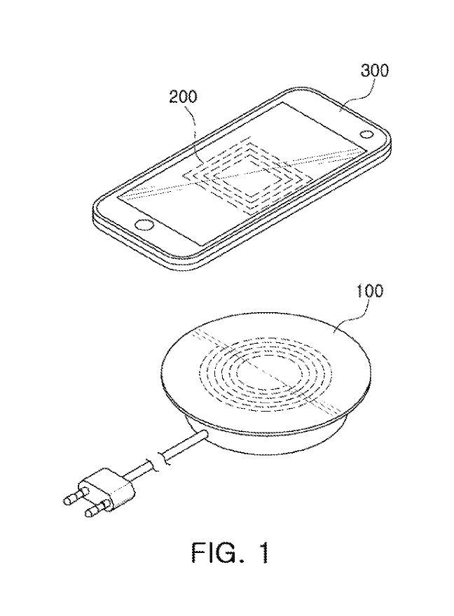

FIG. 1 is a diagram illustrating an application of a wireless power transmitter 100 to supply power to a wireless power receiver 200, according to an embodiment. Referring to FIG. 1, the wireless power receiver 200 may be disposed adjacent to the wireless power transmitter 100 to be magnetically coupled (e.g., magnetically resonated or magnetically induced) to the wireless power transmitter 100, thereby wirelessly receiving power.

The wireless power receiver 200 may provide the received power to an electronic device 300. The wireless power receiver 200 may be incorporated in the electronic device 300, or may be a separate apparatus which is electrically connected to the electronic device 300.

Although the wireless power receiver 200 and the wireless power transmitter 100 are shown as being spaced apart from each other in FIG. 1, this configuration is merely illustrative of an example. Alternatively, the wireless power receiver 200 and the wireless power transmitter 100 may be in contact with each other or may be adjacent to each other.

According to an embodiment, the wireless power transmitter 100 directly receives commercial alternating current (AC) power to be driven. That is, unlike wireless power transmitters of the related art that require a power-supplying apparatus to convert the commercial AC power into direct current (DC) power, the wireless power transmitter 100 directly receives the commercial AC power in order to be operated. Therefore, the wireless power transmitter 100 has advantages in that it may be easily carried and may be miniaturized.

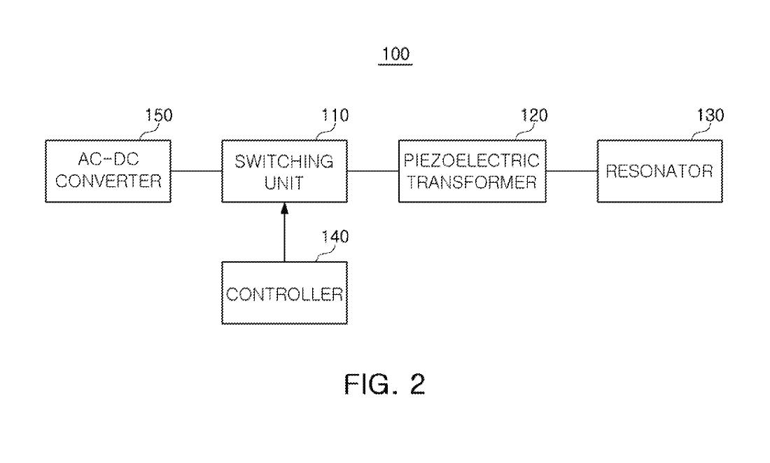

Hereinafter, various embodiments of wireless power transmitters which represent variants of the wireless power transmitter 100 will be described with reference to FIGS. 2 through 7.

FIG. 2 is a block diagram illustrating the wireless power transmitter 100, according to an embodiment. Referring to FIG. 2, the wireless power transmitter 100 includes a switching unit 110, a piezoelectric transformer 120, and a resonator 130. The wireless power transmitter 100 further includes a controller 140 and an AC-DC converter 150. Although the switching unit 110, the controller 140 and the AC-DC converter 150 are illustrated and described as separate components, any two or more of the switching unit 110, the controller 140 and the AC-DC converter 150 may be configured as a single integrated circuit.

The AC-DC converter 150 receives an AC voltage and outputs a DC voltage. For example, the AC-DC converter 150 receives a commercial AC voltage, and rectifies and smoothes the commercial AC voltage to provide the DC voltage.

The switching unit 110 generates a first AC voltage from the DC voltage to provide the first AC voltage to a primary side of the piezoelectric transformer 120. That is, the switching unit 110 receives the DC voltage and performs a switching operation to output the first AC voltage.

The piezoelectric transformer 120 includes a primary side in the form of a first piezoelectric element, and a secondary side in the form of a second piezoelectric element, which physically influence each other.

The piezoelectric transformer 120 inputs the first AC voltage provided from the switching unit 110 to the first piezoelectric element. The first AC voltage causes the first piezoelectric element to vibrate, and the vibration of the first piezoelectric element causes the second piezoelectric element to vibrate. From the mechanical vibration of the second piezoelectric element caused by the first piezoelectric element, the second piezoelectric element outputs a second AC voltage corresponding to the mechanical vibration.

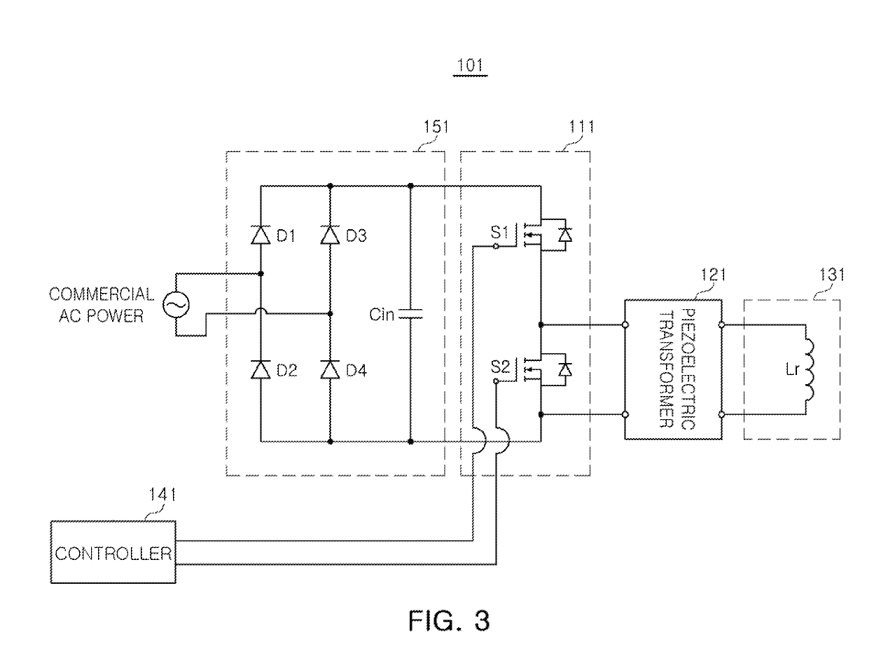

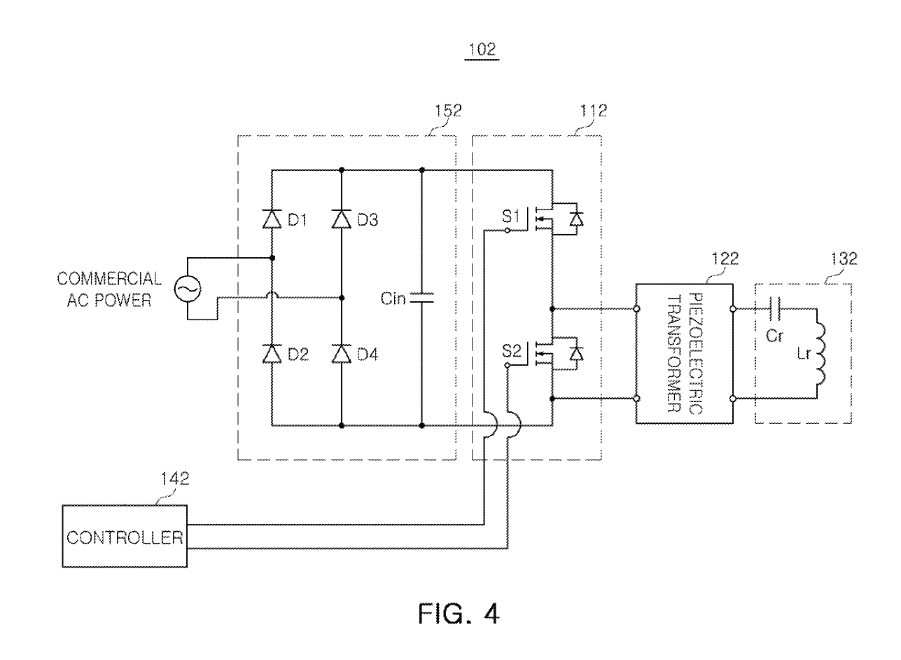

The resonator 130 receives the second AC voltage to wirelessly transmit the power to the wireless power receiver. Various embodiments which are variants of the resonator 130 will be described below in more detail with reference to FIGS. 3 and 4.

The controller 140 provides a control signal to the switching unit 110 to control a switching operation of the switching unit 110. An output of the resonator 130 is varied in accordance with the switching control of the controller 140. To this end, the controller 140 may perform the switching control using various modulation systems such as a pulse width modulation system and a frequency modulation system.

FIG. 3 is a circuit diagram illustrating a wireless power transmitter 101, according to an embodiment. Referring to FIG. 3, a wireless power transmitter 101 includes a switching unit 111, a piezoelectric transformer 121, a resonator 131, a controller 141 and an AC-DC converter 151.

The AC-DC converter 151 is, for example, a circuit including rectifier circuits D1 to D4 and a smoothing capacitor Cin. Although the rectifier circuits D1 to D4 are illustrated as full-wave rectifier circuits, various rectifier circuits such as half-wave rectifier circuits may also be applied. The smoothing capacitor Cin provides the smoothed DC voltage to the switching unit 111.

The switching unit 111 includes switches S1 and S2 operated according to a control of a controller 141. The controller 141 provides a switching control signal to each of the switches S1 and S2, to control each of the switches S1 and S2. In the illustrated example, although a half-bridge inverter is applied to the switching unit 111, various inverters such as a full-bridge inverter may also be applied.

The alternating current provided from the switching unit 111 is input to the first piezoelectric element of the primary side of the piezoelectric transformer 121, and when the vibration of the first piezoelectric element causes the second piezoelectric element to vibrate, the second piezoelectric element provides a voltage to the resonator 131.

The resonator 131 includes a resonance coil Lr. The resonator 131 illustrated does not have a resonance capacitor. Therefore, a resonance frequency of the wireless power transmitter 101 is determined by a resonance frequency of the piezoelectric transformer 121. Since the resonator 131 does not have a resonance capacitor, the switching unit 111 performs a switching operation at a frequency corresponding to the resonance frequency of the piezoelectric transformer 121. That is, since a frequency of the alternating voltage input to the piezoelectric transformer 121 corresponds to the resonance frequency of the piezoelectric transformer 121, output efficiency of the piezoelectric transformer may be significantly increased.

Since the output of the wireless power transmitter may be adjusted, the controller 141 may fix an operating frequency of the switching unit 111 to the resonance frequency of the piezoelectric transformer 121, and may modulate a pulse width of the switching control signal to adjust the output of the resonator 131.

Since the wireless power transmitter 101 is operated based on maximum efficiency of the piezoelectric transformer 121, output efficiency of the wireless power transmitter 101 may be increased. Furthermore, since a capacitor is not required in the resonator 131, the wireless power transmitter 101 may be miniaturized.

FIG. 4 is a circuit diagram illustrating a wireless power transmitter 102, according to another embodiment. Referring to FIG. 4, the wireless power transmitter 102 includes a switching unit 112, a piezoelectric transformer 122, a resonator 132, a controller 142 and an AC-DC converter 152. The switching unit 112, the piezoelectric transformer 122, and the AC-DC converter 152 can be easily understood with reference to those described corresponding elements above with reference to FIG. 3.

The resonator 132 includes a resonance capacitor Cr and the resonance coil Lr. Therefore, a resonance frequency of the wireless power transmitter 102 is determined by a resonance frequency of the resonator 132 and a resonance frequency of the piezoelectric transformer 122.

The switching unit 112 may be switched to a first frequency corresponding to the resonance frequency of the piezoelectric transformer 122, or may be switched to a second frequency, which is different from the first frequency. That is, a controller 142 may change an operating frequency of the switching unit 112 to adjust an output of the wireless power transmitter 102. The operating frequency of the switching unit 112 may also correspond to a resonance frequency of the piezoelectric transformer 122 having high efficiency, or may also be a frequency which is different from the resonance frequency of the piezoelectric transformer 122.

That is, the switching unit 112 is characterized by gain characteristics of a frequency of the resonator 132 which are wide with respect to the frequency, while gain characteristics of a frequency of the piezoelectric transformer 122 are narrow with respect to the frequency. Therefore, since gain characteristics of an overall frequency of the wireless power transmitter 102 are determined by both the gain characteristics of the frequency of the resonator 132 and the gain characteristics of the frequency of the piezoelectric transformer 122, the overall frequency of the wireless power transmitter 102 may have gain characteristics corresponding to an intermediate value of the gain characteristics of the frequency of the resonator 132 and the gain characteristics of the frequency of the piezoelectric transformer 122. As a result, since the wireless power transmitter 102 has relatively small gain loss, even in a case in which a frequency change occurs, stable performance of the wireless power transmitter may also be provided by a switching adjustment of a frequency control system.

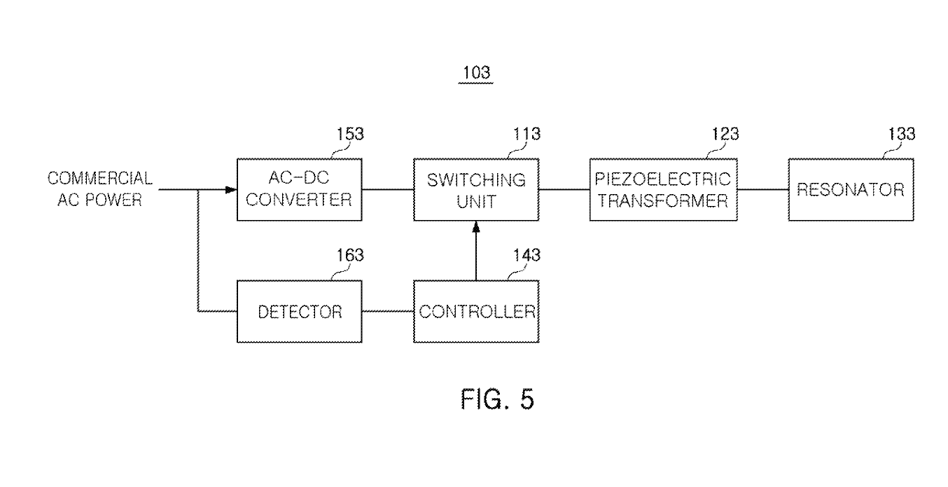

FIG. 5 is a block diagram illustrating the wireless power transmitter 103, according to another embodiment. The example illustrated in FIG. 5 relates to changing a switching control in response to a change of commercial AC input power.

Referring to FIG. 5, the wireless power transmitter 103 includes a switching unit 113, a piezoelectric transformer 123, a resonator 133, a controller 143, an AC-DC converter 153, and a detector 163. Although the switching unit 113, the controller 143, the AC-DC converter 153, and the detector 163 are illustrated and described as separate components, any two or more of the switching unit 113, the controller 143, the AC-DC converter 153, and the detector 163 may be configured as a single integrated circuit. The switching unit 113, the piezoelectric transformer 123, the resonator 133, and the AC-DC converter 153 can be easily understood from descriptions of the corresponding elements above with reference to FIGS. 2 through 4.

The detector 163 measures a peak voltage level of a commercial AC voltage. For example, the detector 163 periodically measures the peak voltage level of the commercial AC voltage. Therefore, a change of the commercial AC voltage may be confirmed from a change of an output of the detector 163.

The controller 143 adjusts the switching control signal provided to the switching unit 113. For example, the controller 143 modulates a pulse width of the switching control signal, or adjusts a frequency of the switching control signal, in response to a change of the peak voltage level of the commercial AC voltage.

According to an embodiment, the controller 143 reduces the pulse width of the switching control signal in response to the peak voltage level of the commercial AC voltage exceeding a threshold level (e.g., a predetermined threshold level). Additionally, in such an embodiment, the controller 143 increases the pulse width of the switching control signal in response to the peak voltage level of the commercial AC voltage being lower than the threshold level.

According to an embodiment, the controller 143 increases the frequency of the switching control signal in response to the peak voltage level of the commercial AC voltage exceeding the threshold level. Additionally, in such an embodiment, the controller 143 reduces the frequency of the switching control signal in response to the peak voltage level of the commercial AC voltage being lower than the threshold level.

As such, since the controller 143 may maintain an input of the piezoelectric transformer 123 to be constant by adjusting the switching control in response to a change of an input value of the commercial AC voltage, the controller 143 may stabilize output characteristics of the piezoelectric transformer 123 accordingly, and may also control the output of the wireless power transmitter 103 to be constant.

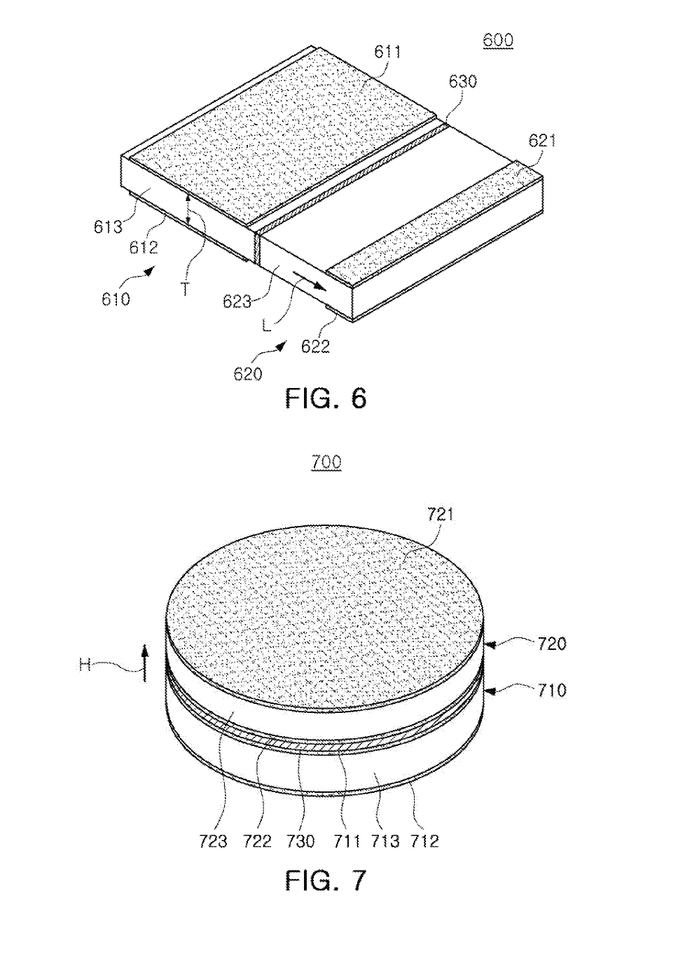

FIGS. 6 and 7 are diagrams illustrating examples of a piezoelectric transformers 600 and 700, respectively, which are variations of the piezoelectric transformers 120-123 illustrated in FIGS. 1-5.

FIG. 6 is a diagram illustrating a planar piezoelectric transformer, according to an embodiment. Referring to FIG. 6, the piezoelectric transformer 600 includes a first piezoelectric element 610 and a second piezoelectric element 620 which are electrically separated from each other. The first piezoelectric element 610 is, for example, an input piezoelectric element, and the second piezoelectric element 620 is, for example, an output piezoelectric element.

The input piezoelectric element 610 includes input piezoelectric layers 613 stacked in a first direction, and input electrodes 611 and 612 disposed on opposite external surfaces of the input piezoelectric layers 613. An input voltage may be applied through the input electrodes 611 and 612.

The output piezoelectric element 620 includes output piezoelectric layers 623 stacked in a second direction, and output electrodes 621 and 622 disposed on opposite external surfaces of the output piezoelectric layers 623. An output voltage may be output through the output electrodes 621 and 622.

Internal electrodes (not shown) may be formed to intersect each other within the piezoelectric layers 613 and 623, and the internal electrodes may be connected to the input electrodes 611 and 612 or the output electrodes 621 and 622, depending on polarities of the input electrodes 611 and 612 and the output electrodes 621 and 622.

In the illustrated example, polarization directions of the input piezoelectric layers 613 and the output piezoelectric layers 623 are different from each other. In the illustrated example, the polarization direction of the input piezoelectric element 610 is formed in a thickness direction T, and the polarization direction of the output piezoelectric element 620 is formed in a length direction L. However, since this example is merely illustrative, the polarization directions of the input piezoelectric layers 613 and the output piezoelectric layers 623 may also be the same as each other.

When AC power is applied to the input piezoelectric element 610, the input piezoelectric element 610 vibrates, and the vibration of the input piezoelectric element 610 causes the output piezoelectric element 620 to vibrate. The output piezoelectric element 620 generates electrical energy from its vibration, as described above, to output a voltage.

An insulating layer 630 is disposed between the input piezoelectric element 610 and the output piezoelectric element 620, to thereby electrically insulate the input piezoelectric element 610 and the output piezoelectric element 620 from each other. The insulating layer 630 may be formed of various materials having an insulating property.

In an example, the insulating layer 630 is formed of a ceramic material having a high insulating property. Alternatively, the insulating layer 630 may be formed of a resin material, and may be formed in a sheet or film shape.

In another example, a thin film having both an insulating property and ductility is used for the insulating layer 630. Ductility of the insulating layer 630 is advantageous because a degree of fatigue is increased by the vibration of the input piezoelectric transformer 600, which may cause cracks or other damage in the insulating layer 630 in a case in which the insulating layer 630 is formed of ceramic material. Additionally, it is advantageous for the insulating layer 630 to have both an insulating property and ductility because, without these characteristics, the vibration of the input piezoelectric element 610 may not be smoothly transferred to the output piezoelectric element 620, due to the hardness of the ceramic material.

According to an embodiment, at least one hollow, which is filled with air or is an empty space, is formed in the insulating layer 630. Since the hollow is filled with air, or is formed as an empty space, which is a vacuum state, the input piezoelectric element 610 and the output piezoelectric element 620 are electrically separated from each other by the hollow. The insulating layer 630 in which the hollow is formed may have an actual volume which is much smaller than in a case in which the hollow is not formed, and therefore may efficiently transfer the vibration to the output piezoelectric element 620, while significantly reducing attenuation of the vibration of the input piezoelectric element 610.

FIG. 7 is a diagram illustrating a stacked piezoelectric transformer 700, according to an embodiment. Referring to FIG. 7, the piezoelectric transformer 700 includes a first piezoelectric element 710, a second piezoelectric element 720, and an insulating layer 730 disposed between the first and second piezoelectric elements 710 and 720, wherein the first piezoelectric element 710 and the second piezoelectric element 720 are electrically separated from each other.

However, unlike the example illustrated in FIG. 6, the piezoelectric transformer 700, the input piezoelectric element 710 and the output piezoelectric element 720 are stacked in the same direction. That is, in the illustrated example, input piezoelectric layers 713 of the input piezoelectric element 710 are stacked in a first direction, a height direction H, and output piezoelectric layers 723 of the output piezoelectric element 720 are also stacked in the height direction H.

The input piezoelectric element 710 includes input electrodes 711 and 712 disposed on opposite sides of the input piezoelectric layers 713. The output piezoelectric element includes output electrodes 721 and 722 disposed on opposite sides of the output piezoelectric layers 723.

When AC power is applied to the input piezoelectric element 710, the input piezoelectric element 710 vibrates in a vertical direction (the height direction H), and the vibration of the input piezoelectric element 710 causes the output piezoelectric element 720 to vibrate in the vertical direction. The output piezoelectric element 720 generates alternating voltage from its vibration, as described above.

The insulating layer 730 can be easily understood from the description of the insulating layer 630 with reference to FIG. 6.

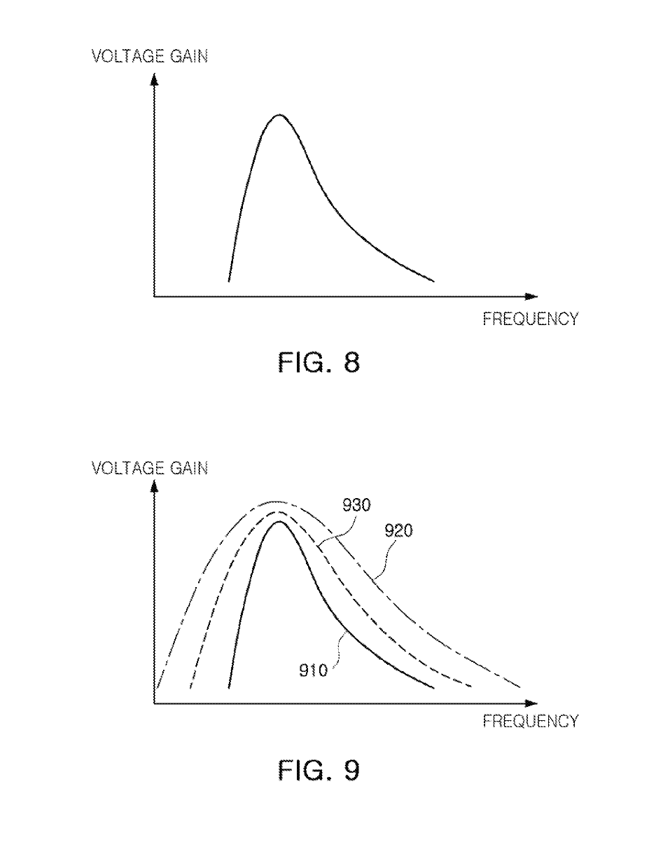

FIG. 8 is a graph illustrating characteristics of a voltage gain in relation to a frequency of a piezoelectric transformer, according to an embodiment. Since, in the embodiment of FIG. 3, the resonator 131 does not include a capacitor, characteristics of the voltage gain with respect to a frequency of the wireless power transmitter 101 of FIG. 3 may be similar to the graph illustrated in FIG. 8.

As can be seen from the illustrated graph, a gain of the piezoelectric transformer 121 may increase according to a change of the frequency. Therefore, a method of securing higher efficiency of the piezoelectric transformer includes operating the piezoelectric transformer 121 in a certain frequency range capable of securing a sufficient gain, for example, at or near the resonance frequency.

FIG. 9 is a graph illustrating characteristics of a voltage gain with respect to a frequency of a wireless power transmitter, according to an embodiment. The graph illustrated in FIG. 9 illustrates characteristics of a voltage gain of the case in which the resonator 132 includes the capacitor, as in the example described with reference to FIG. 4.

Referring to FIG. 9, a graph 910, indicated by a solid line, illustrates characteristics of a voltage gain with respect to a frequency of the piezoelectric transformer 122, and a graph 920, indicated by a dashed-dotted line, illustrates characteristics of a voltage gain with respect to a frequency of the resonator 132.

Therefore, the wireless power transmitter 102 may have characteristics of a voltage gain with respect to a frequency indicated by the dotted line in graph 930, in which characteristics of the piezoelectric transformer 122 and characteristics of the resonator 132 are reflected.

It can be seen that the voltage gain characteristics illustrated by the graph 930 have a wider range of frequency than the voltage gain characteristics illustrated in the example of FIG. 8. Therefore, in the embodiment of FIG. 9, sufficient output efficiency may be provided even in a case in which a frequency modulation system is used.

As set forth above, according to the embodiments described herein, a wireless power transmitter may include a transformer circuit having a reduced size, whereby the wireless power transmitter may be miniaturized and may have a thin form.

The switching unit 110, the controller 140, and the AC-DC converter 150 in FIG. 2, and the switching unit 113, the controller 143, the AC-DC converter 153, and the detector 163 in FIG. 5 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmitter comprising:
a switching unit configured to receive a direct current (DC) voltage and to perform switching to output a first alternating current (AC) voltage;
a piezoelectric transformer configured to receive the first AC voltage through a first piezoelectric element, and to output a second AC voltage corresponding to mechanical vibration of a second piezoelectric element caused by mechanical vibration of the first piezoelectric element; and
a resonator configured to receive the second AC voltage to wirelessly transmit power.

2. The wireless power transmitter of claim 1, wherein:
the resonator comprises a resonance coil; and
the switching unit is configured to be switched at a frequency corresponding to a resonance frequency of the piezoelectric transformer.

3. The wireless power transmitter of claim 2, further comprising a controller configured to:
provide a switching control signal to the switching unit to control the switching of the switching unit; and
modulate a pulse width of the switching control signal to adjust an output of the resonator.

4. The wireless power transmitter of claim 1, wherein:
the resonator comprises a resonance capacitor and a resonance coil; and
the switching unit is configured to be switched at one of a first frequency corresponding to a resonance frequency of the piezoelectric transformer, and a second frequency which is different from the first frequency.

5. The wireless power transmitter of claim 4, wherein a frequency band of gain characteristics of the resonator is wider than a frequency band of gain characteristics of the piezoelectric transformer.

6. The wireless power transmitter of claim 1, further comprising an AC-DC converter configured to receive a commercial AC voltage to output the DC voltage.

7. The wireless power transmitter of claim 6, further comprising:
a detector configured to measure a peak voltage level of the commercial AC voltage; and
a controller configured to
provide a switching control signal to the switching unit to control the switching of the switching unit, and
adjust one of a pulse width and a frequency of the switching control signal in response to a change of the peak voltage level.

8. The wireless power transmitter of claim 7, wherein the controller is configured to reduce the pulse width of the switching control signal, in response to the peak voltage level exceeding a threshold level.

9. The wireless power transmitter of claim 7, wherein the controller is configured to increase the pulse width of the switching control signal, in response to the peak voltage level being less than a threshold level.

10. The wireless power transmitter of claim 7, wherein the controller is configured to increase the frequency of the switching control signal, in response to the peak voltage level exceeding a threshold level.

11. The wireless power transmitter of claim 7, wherein the controller is configured to reduce the frequency of the switching control signal, in response to the peak voltage level being less than a threshold level.

12. The wireless power transmitter of claim 7, wherein the controller is configured to control an output of the wireless power transmitter to be constant by the adjusting of the one of the pulse width and the frequency of the switching control signal.

13. A resonance module of a wireless power transmitter, the resonance module comprising:
a piezoelectric transformer configured to receive a first alternating current (AC) voltage through a first piezoelectric element, and to output a second AC voltage corresponding to mechanical vibration of a second piezoelectric element caused by mechanical vibration of the first piezoelectric element; and
a resonator configured to receive the second AC voltage to wirelessly transmit power.

14. The resonance module of claim 13, wherein:
the resonator comprises a resonance coil; and
the first AC voltage comprises a frequency corresponding to a resonance frequency of the piezoelectric transformer.

15. The resonance module of claim 14, wherein the resonator excludes a capacitor.

16. The resonance module of claim 13, wherein:
the resonator comprises a resonance capacitor and a resonance coil; and
the first AC voltage comprises one of a first frequency corresponding to a resonance frequency of the piezoelectric transformer and a second frequency which is different from the first frequency.

17. The resonance module of claim 16, wherein a frequency band of gain characteristics of the resonator is wider than a frequency band of gain characteristics of the piezoelectric transformer.

18. A wireless power transmitter comprising:
a switching unit configured to receive a direct current (DC) voltage and to perform switching to output a first alternating current (AC) voltage;
a piezoelectric transformer configured to receive the first AC voltage through a first piezoelectric element, and to output a second AC voltage corresponding to mechanical vibration of a second piezoelectric element caused by mechanical vibration of the first piezoelectric element;
a resonator configured to receive the second AC voltage to wirelessly transmit power; and
a controller configured to
provide a switching control signal to the switching unit to control the switching of the switching unit, and
control an output of the wireless power transmitter to be constant by adjusting the switching control signal.

19. The wireless power transmitter of claim 18, further comprising:
a converter configured to receive a commercial alternating current (AC) voltage to output the DC voltage,
wherein the adjusting of the switching control signal comprises adjusting one of a pulse width and a frequency of the switching control signal, in response to a change of a peak voltage level of the commercial AC voltage.

20. The wireless power transmitter of claim 19, further comprising a detector configured to measure the peak voltage level of the commercial AC voltage.
